(19) United States
(12) Patent Application Publication
(10) Pub. No.: US 2005/0249843 A1
(43) Pub. Date: Nov. 10, 2005

(54) Low carbohydrate caramel corn composition

(76) Inventor: Loren Wallis, Glendale, CA (US)

Correspondence Address: HOFFMANN & BARON, LLP, 6900 JERICHO TURNPIKE, SYOSSET, NY, 11791, US

(21) Appl. No.: 10/841,805

(22) Filed: May 7, 2004

(51) Int. Cl. A23G 1/00

(52) U.S. Cl. 426/89

(57) ABSTRACT

A low carbohydrate caramel corn composition that comprises popped corn and a caramel coating. The popped corn is coated with the caramel coating. The caramel coating comprises a sugar alcohol. The composition contains a maximum of about 10 grams of sugar alcohol per one ounce serving and a maximum of about 9 grams of net carbohydrates per one ounce serving.

### BACKGROUND OF THE INVENTION

The present invention relates generally to a low carbohydrate caramel corn composition.

Low carbohydrate dieting has become extremely popular in the last decade or so. Traditional nutritionists favor diets which are based on the “food pyramid.” The “food pyramid” promotes consumption of large amounts of high carbohydrate foods. Many individuals desiring weight loss that adhere to the “food pyramid” when making food choices have failed at losing weight.

In contrast, many individuals that have employed diets low in carbohydrates have had tremendous success losing weight. In a low carbohydrate diet, rather than restricting consumption of fat or calories, the diet generally advocates restricting carbohydrates so that additional glucose or sugars are not added to the body's metabolism. As a result, it is believed that the body, instead of burning carbohydrates consumed as a fuel source, bums stored fat for fuel.

For example, the Atkins Diet® promotes a diet low in carbohydrates. The Atkins Diet® varies significantly from the recommended diets of the American Heart Association and the National Institutes of Health. Individuals who follow the Atkins Diet® must monitor their daily intake of carbohydrates.

According to the Atkins Diet®, the maximum daily intake of carbohydrates for weight loss is between 15 and 60 grams of carbohydrates per day. Therefore, any foods consumed by an individual following such a low-carbohydrate diet should contain low amounts of carbohydrates.

One criticism of low carbohydrate diets has been the lack of food choices and the resulting difficulty that some people have staying within the limited choices over the long term. In particular, there is a need for more low carbohydrate snack foods.

Caramel coated popped corn is a popular snack food. Traditional caramel coated popped corn snack foods like Cracker Jack® by Frito-Lay, Inc. are very high in carbohydrates. For example, Cracker Jack® contains about 23 grams of carbohydrates per one ounce serving.

A sugar-free caramel corn product sold under the brand name Golightly™ contains 24 grams of sugar alcohols (isomalt) in about a one ounce serving. The laxative threshold, as will be discussed below, for isomalt is 50 grams/day. Consumption of 24 grams of sugar alcohol in a one ounce serving can be associated with intestinal side effects, as will be discussed below.

Other known caramel coated popped corn compositions, such as the reduced calorie caramel flavored popcorn disclosed in U.S. Pat. No. 5,215,770, contains approximately 25 to 27 grams of carbohydrates per one ounce serving. Thus, it would be beneficial to have a caramel coated popped corn which is low in net carbohydrates and low in sugar alcohol content.

### SUMMARY OF THE INVENTION

The above needs have been met by the present invention which provides a low carbohydrate caramel corn composition. The composition comprises popped corn and a caramel coating. According to the invention, the popped corn is coated with the caramel coating. The caramel coating comprises a sugar alcohol. The composition contains a maximum of about 10 grams of sugar alcohol per one ounce serving and a maximum of about 9 grams of net carbohydrates per one ounce serving.

In one embodiment of the invention, the corn is oil popped. In another embodiment, the corn is air popped. Preferably, the popped corn is present in the composition in a maximum amount of about 40% by weight based on the total weight of the composition. More preferably, the popped corn is present in the composition in a minimum amount of about 15% by weight based on the total weight of the composition.

According to the invention, the sugar alcohol is preferably maltitol. The sugar alcohol can also be mannitol, sorbitol, xylitol, lactitol, isomalt, maltitol, erythritol, hydrogenated starch hydrolysates or a combination thereof. In one embodiment, the caramel coating further comprises a natural sweetener.

In another embodiment, the caramel coating further comprises a high intensity sweetener. The high intensity sweetener can be sucralose, stevia, lohan or acesulfame-K, or a combination thereof.

Preferably, the caramel coating is present in the composition in a maximum amount of about 85% by weight based on the total weight of the composition. More preferably, the caramel coating is present in the composition in a minimum amount of about 60% by weight based on the total weight of the composition.

In yet another embodiment, the caramel coating further comprises natural color and/or natural flavor. Preferably, the caramel coating further comprises butter, milk and/or cream.

In one embodiment, the caramel coating further comprises salt. In another embodiment, the composition further comprises nuts.

In a preferred embodiment, the ratio of sugar alcohol to high intensity sweetener is from about 99:1 to about 1:99. In another embodiment the ratio of the sugar alcohol to high intensity sweetener is about 50:50. In yet another embodiment, the ratio of sugar alcohol to high intensity is about 90:10. In another embodiment, the ratio of sugar alcohol to high intensity sweetener is about 15:85.

Finally, in a preferred embodiment, the composition contains a minimum of about 1 gram of net carbohydrates per one ounce serving.

### DETAILED DESCRIPTION ON THE INVENTION

The invention provides a low carbohydrate caramel corn composition. The composition comprises popped corn and a caramel coating, wherein the caramel coating comprises a sugar alcohol.

The composition comprises popped corn. The corn is any corn suitable for popping and human consumption. Examples of such corn include dent corn (scientific name: Zea mays indenata) and flint corn (scientific name: Zea mays indurate). Examples of flint corn include sweet corn (scientific name: Zea saccharata or Zea rugosa), flour corn (scientific name: Zea mays amylacea) and popcorn corn (scientific name: Zea mays everta). Any of the above listed corns can be yellow or white.

Preferably, the corn is popcorn corn. Any method known to those skilled in the art can be used to pop corn kernels. Typically, corn kernels are heated to produced a popped corn. When the corn kernel is heated, the natural moisture inside the kernel typically turns to steam, which causes build-up of pressure in the kernels. Once enough pressure builds up, the kernel explodes or pops.

The corn kernels can be heated by any method known to those in the art. Such methods include, for example, heating the kernels in oil or with air.

Oil popped corn as used in this specification refers to corn kernels which are heated (popped) in oil. The oil is any oil suitable for popping corn. Examples of such oils include corn oil, peanut oil, soybean oil, vegetable oil, sunflower oil, safflower oil and canola oil. Typically, to pop corn kernels in oil, the oil is heated to a temperature between about 400° F. to about 460° F. Air popped corn as used herein refers to corn kernels which are heated (popped) with hot air.

The popped corn is present in the composition in a minimum amount of about 15% by weight based on the total weight of the composition, and preferably a minimum of about 22% by weight based on the total weight of the composition. The maximum amount of popped corn present in the composition is about 40% by weight based on the total weight of the composition, and preferably a maximum of about 28% by weight based on the total weight of the composition. A suitable range of amount of popped corn in the composition may be obtained by combining any of the above minima with any of the above maxima.

The popped corn is coated with a caramel coating. By “coated” it is meant that the caramel coating is adhered to the outside surface of the popped corn. The caramel coating can be partially or completely adhered to the outside surface of the popped corn.

The “caramel coating” is a hardened, candied shell which can completely or partially coat the popped corn. The caramel coating is present in the composition in a minimum amount of about 60% by weight based on the total weight of the composition, and preferably a minimum of about 65% by weight based on the total weight of the composition.

The maximum amount of caramel coating present in the composition is about 80% based on the total weight of the composition, and preferably a maximum of about 75% based on the total weight of the composition. A suitable range of amount of caramel coating in the composition may be obtained by combining any of the above minima with any of the above maxima.

The caramel coating comprises a sugar alcohol. Sugar alcohols (or polyols) are generally alcohols derived from sugar molecules. Examples of sugar alcohols useful in the composition of the present invention include, but are not limited to, mannitol, sorbitol, xylitol, lactitol, isomalt, maltitol, erythritol, hydrogenated starch hydrolysates or a combination thereof.

Mannitol refers to the alcohol form of mannose. It occurs naturally in pineapples, olives, asparagus, sweet potatoes, and carrots. Mannitol is generally extracted from seaweed for use in food manufacturing. Mannitol normally has about 50% to 70% of the relative sweetness of sugar.

Sorbitol refers to the alcohol form of sucrose. It occurs naturally in some fruits and berries. Sorbitol can be commercially produced by the hydrogenation of glucose and can be purchased in either liquid or crystalline form. Sorbitol normally has about 60% of the relative sweetness of sugar with about one-third fewer calories.

Xylitol, also called “wood sugar,” refers to the alcohol form of xylose and is represented by the chemical formula C₅H₁₂O₅. It occurs naturally in straw, corncobs, fruit, vegetables, cereals, mushrooms, and some seaweeds. In addition, xylitol is produced by the human body during normal metabolism. For use in food manufacturing, xylitol is generally extracted from birch and other hard wood trees and fibrous vegetation. Xylitol has the same sweetness and bulk as sugar with one-third fewer calories and no unpleasant aftertaste.

Lactitol is a sugar alcohol which is typically produce by reducing the glucose portion of the disaccharide lactose. Lactitol has about 30% to about 40% of the sweetness of sugar and about half the calories.

Isomalt is a mixture of two disaccharide alcohols, gluco mannitol and gluco sorbitol. Isomalt is typically prepared by a two-step process which begins with sucrose. In the first step, an enzyme rearranges the linkage between glucose and fructose in sucrose. In the second step, two hydrogens are added to an oxygen in the fructose portion of the disaccharide. Approximately half of the fructose portion of the original disaccharide is converted to mannitol and about half of the fructose portion of the original disaccharide is converted to sorbitol. The molecular changes that occur in these steps generally cause isomalt to be more chemically and enzymatically stable than sucrose. Isomalt has about 45% to about 65% of the sweetness of sugar.

Erythritol (sold as C*Eridex™ by Cerestar), is represented by the chemical structure 1,2,3,4-butanetetrol meso-erythritol. Erythritol is an natural sweetener found in many fruits and vegetables. Erythritol is also manufactured using glucose and a fermentation process.

Hydrogenated starch hydrolysates (HSH) refers to any polyol produced by the hydrogenation of the saccharide products of starch hydrolysis. HSH are generally produced by the partial hydrolysis of corn, wheat or potato starch and subsequent hydrogenation of the hydrolysate at high temperature under pressure. The end product is an ingredient composed of sorbitol, maltitol and higher hydrogenated saccharides, such as maltitriitol. By varying the conditions and extent of hydrolysis, the relative occurrence of various mono-, di-, oligo- and polymeric hydrogenated saccharides in the resulting product can be obtained.

The composition contains a maximum of about 10 grams of sugar alcohol per one ounce serving. It is known that consuming certain amounts of sugar alcohols can produce intestinal side effects such as diarrhea, cramping, etc. Each individual sugar alcohol has a laxative threshold for human consumption. The laxative threshold for each sugar alcohol is the amount of that sugar alcohol that can be safely consumed by a human per day, to avoid the possible intestinal side effects.

Table 1, below, sets forth the laxative threshold for several sugar alcohols.

TABLE 1
Laxative Thresholds of Sugar Alcohols

| | % Relative | | |
|---|---|---|---|
| | Sweetness | | Laxation |
| Sugar | versus | Caloric | Threshold |
| alcohol | Sucrose | USA | (g/day) |
| Sorbitol | 60 | 2.6 | 50 |
| Mannitol | 50 | 1.6 | 20 |
| HSH | 70-80 | 3** | 70-80 |
| Maltitol | 90 | 3 | 100 |
| Xylitol | 100 | 2.4 | 50 |
| Lactitol | 30-40 | 2 | 50 |
| monohydrate | | | |
| Anhydrous | 40 | 2 | 50 |
| isomalt | | | |
| Erythritol | 60-70 | 0.4 | High |
| Glycerine | 55-75 | 4 | ? |
| Polydextrose | 0 | 1 | 90 |

*all amounts are approximate

In a preferred embodiment of the invention, the composition contains a maximum of about 10% of the daily Taxation threshold for the sugar alcohol used. For example, maltitol has a daily Taxation threshold of about 100 grams/day. Therefore, if maltitol is the sugar alcohol used in the composition, the maltitol is present in a maximum amount of about 10 grams per one ounce serving.

The caramel coating can further comprise a high intensity sweetener. High intensity sweeteners are a class of sweeteners that provide a higher a degree of sweetness when compared to natural sugars. High intensity sweeteners include sweeteners such as, for example, sucralose, acesulfame-K, stevia or lohan extract. Combinations of high intensity sweeteners can be used.

Sucralose, available as Splenda® by McNeil Specialty Products, a subsidiary of Johnson & Johnson, is a non-caloric, high intensity sweetener made from a process that begins with sucrose. Sucralose is derived through a multi-step process that selectively substitutes three atoms of chlorine for three hydroxyl groups on sucrose. Sucralose is 600 times sweeter than sugar.

Stevia is a naturally occurring, high intensity sweetener derived from a chrysanthemum plant native to Paraguay. Stevia is about 70-300 times sweeter than sugar, depending upon the form it is used in (e.g. liquid or powder).

Acesulfame-K (or acesulfame potassium) is a high intensity, non-caloric sweetener having the chemical formula C₄H₄NO₄KS. Acesulfame-K is sold under the brand name Sunett™ by Nutrinova, Inc.

According to the invention, the ratio of sugar alcohol to high intensity sweetener is from about 99:1 to about 1:99. For example, in a preferred composition according to the invention, the ratio of the sugar alcohol to high intensity sweetener is about 50:50.

In another example, the ratio of sugar alcohol to high intensity is about 90:10 or about 15:85. The ratio of sugar alcohol to high intensity sweetener can easily be determined by the skilled practitioner.

The caramel coating can optionally contain other sweeteners. By “other sweeteners,” it is meant that sweeteners other than high intensity sweeteners and sugar alcohols are used. For example, other sweeteners includes natural sweeteners.

The natural sweeteners are any natural sweetener suitable for human consumption. Examples of such sweeteners include monosaccharides such as glucose and fructose, and oligosaccharides such as disaccharides (e.g., dextrose, sucrose, lactose, maltose and isomaltose). Combinations of natural sweeteners can be used.

The amount of sweetener (i.e. sugar alcohol, high intensity sweetener and natural sweetener) used in the caramel coating usually depends on the nature of the sweetener. Such factors include, for example, the type of sweetener used, the sweetness of the sweetener, and the bulkiness of the sweetener. The amount of sweetener used can easily be determined by the skilled practitioner.

In a preferred embodiment of the invention, the sweetener used in the caramel coating comprises a combination of one or more sugar alcohol(s) and one or more high intensity sweetener(s). For example, in a preferred embodiment, approximately 50% mannitol and approximately 50% sucralose is used as the sweetener in the caramel coating.

The caramel coating usually also comprises butter, cream or milk. The caramel coating can optionally comprise a natural color additive. Natural color additives are generally color additives derived from plant or animal sources. Examples include, but are not limited to, carmine/cochineal, annatto extract, grape skin extract, turmeric, saffron, beta-carotene and caramel color liquid (typically extracted from bunt sugar).

The caramel coating can also optionally comprise natural flavoring. Examples of natural flavors include vanilla, caramel and butter flavors. In a preferred embodiment, the caramel coating further comprises baking soda.

The coating is present in the composition in a maximum amount of about 85% by weight based on the total weight of the composition, and preferably a maximum of about 75% by weight based on the total weight of the composition. The minimum amount of coating present in the composition is about 60% by weight based on the total weight of the composition, and preferably a minimum of about 65% by weight based on the total weight of the composition. A suitable range of amount of coating present in the composition may be obtained by combining any of the above minima with any of the above maxima.

The low carbohydrate caramel corn composition can optionally comprise nuts. Any type of nut suitable for human composition can be included in the composition of the present invention. Examples of nuts include peanuts, cashews, almonds, walnuts, hazelnuts, macadamia nuts, pistachios, soy nuts and pecans.

The nuts present in the composition can be whole nuts, nut pieces, small chopped nut pieces, or combinations thereof. In the composition of the present invention, the nuts can be adherent to the caramel coated popped corn, coated with the caramel coating, and/or non-adherent to the caramel coated popped corn.

If nuts are present in the composition, the nuts are present in the composition in a minimum amount of about 1% by weight based on the total weight of the composition, and preferably a minimum amount of about 2% by weight based on the total weigh of the composition. The maximum amount of nuts present in the composition is about 18%, and preferably a maximum amount of about 15% based on the total weight of the composition.

The low carbohydrate caramel corn composition of the present invention contains a maximum amount of about 9 grams of net carbohydrates per one ounce serving, and preferably a maximum amount of about 8 grams of net carbohydrates per one ounce serving.

The amount of “net” carbohydrates per serving is determined by subtracting those carbohydrates that have a negligent effect on blood sugar levels from the total number of carbohydrates. For example, fiber and sugar alcohols have a negligent effect on blood sugar level. Thus, fiber and sugar alcohols do not contribute to “net” carbohydrate amounts.

For example, when determining the amount of net carbohydrates of a product that contains 20 grams of total carbohydrates, and 3 grams of fiber, one would subtract the amount of fiber from the total amount of carbohydrates (20−3=17) and be left with 17 grams of “net” carbohydrates.

Similarly, a product containing 20 grams of total carbohydrates and 10 grams of a sugar alcohol, such as maltitol, would have (20−10=10) 10 grams of “net” carbohydrates.

### EXAMPLES

The following are examples of preferred low carbohydrate caramel corn compositions according to the present invention. All percentages (%) are approximate.

### Example 1

| Ingredient | % |
|---|---|
| Caramel Syrup | 57.48 |
| containing about 50% mannitol, | |
| about 20% sucralose, and about 30% sucrose | |
| Air popped corn | 16.91 |
| Spanish peanuts | 22.99 |
| Vanilla Natural flavor | 0.85 |
| Baking Soda | 0.42 |
| Lecithin | 1.35 |
| Total | 100.0 |

Approximate Total Carbohydrates per one ounce serving = 19 grams
Approximate Net Carbohydrates per one ounce serving = 8 grams
Approximate Sugar Alcohols per one ounce serving = 10 grams

### Example 2

| Ingredient | % |
|---|---|
| Caramel Syrup | 50.81 |
| containing about 60% maltitol, 10% sucralose | |
| and about 30% sucrose | |
| Vegetable oil popped corn | 19.55 |
| Spanish peanuts | 26.59 |
| Vanilla Natural Flavor | 0.98 |
| Baking Soda | 0.49 |
| Lecithin | 1.56 |
| Total | 100.0 |

Approximate Total Carbohydrates per one ounce serving = 17 grams
Approximate Net Carbohydrates per one ounce serving = 7 grams
Approximate Sugar Alcohols per one ounce serving = 9 grams

### Example 3

| Ingredient | % |
|---|---|
| Caramel Syrup | 60.20 |
| containing about 90% sucralose | |
| and about 10% Maltitol | |
| Air popped corn | 20.06 |
| Spanish peanuts | 17.55 |
| Vanilla Natural Flavor | 0.63 |
| Baking Soda | 0.31 |
| Lecithin | 1.25 |
| Total | 100.0 |

Approximate Total Carbohydrates per one ounce serving = 19 grams
Approximate Net Carbohydrates per one ounce serving = 6 grams
Approximate Sugar Alcohols per one ounce serving = 10 grams

### Example 4

| Ingredient | % |
|---|---|
| Caramel Syrup | 45.00 |
| containing about 15% sucralose | |
| and about 85% Maltitol | |
| Air popped or oil popped corn | 41.89 |
| Spanish peanuts | 10.55 |
| Vanilla Natural Flavor | 1.00 |
| Baking Soda | 0.31 |
| Lecithin | 1.25 |
| Total | 100.0 |

Approximate Total Carbohydrates per one ounce serving = 22 grams
Approximate Net Carbohydrates per one ounce serving = 9 grams
Approximate Sugar Alcohols per one ounce serving = 10 grams

1. A low carbohydrate caramel corn composition comprising popped corn and a caramel coating, wherein the caramel coating comprises a sugar alcohol, wherein the popped corn is coated with the caramel coating, and wherein the composition contains a maximum of about 10 grams of sugar alcohol per one ounce serving and a maximum of about 9 grams of net carbohydrates per one ounce serving.

2. A composition according to claim 1, wherein the corn is oil popped.

3. A composition according to claim 1, wherein the corn is air popped.

4. A composition according to claim 1, wherein the popped corn is present in the composition in a maximum amount of about 40% by weight based on the total weight of the composition.

5. A composition according to claim 1, wherein the popped corn is present in the composition in a minimum amount of about 15% by weight based on the total weight of the composition.

6. A composition according to claim 1, wherein the sugar alcohol is maltitol.

7. A composition according to claim 1, wherein the sugar alcohol is mannitol, sorbitol, xylitol, lactitol, isomalt, erythritol, hydrogenated starch hydrolysates or a combination thereof.

8. A composition according to claim 1, wherein the caramel coating further comprises a high intensity sweetener.

9. A composition according to claim 1, wherein the caramel coating further comprises a natural sweetener.

10. A composition according to claim 8, wherein the high intensity sweetener is sucralose, stevia, lohan or acesulfame K, or a combination thereof.

11. A composition according to claim 1, wherein the caramel coating is present in the composition in a maximum amount of about 85% by weight based on the total weight of the composition.

12. A composition according to claim 1, wherein the caramel coating is present in the composition in a minimum amount of about 60% by weight based on the total weight of the composition.

13. A composition according to claim 1, wherein the caramel coating further comprises natural color and/or natural flavor.

14. A composition according to claim 1, wherein the caramel coating further comprises butter.

15. A composition according to claim 1, wherein the caramel coating further comprises milk and/or cream.

16. A composition according to claim 1, wherein the caramel coating further comprises salt.

17. A composition according to claim 1, wherein the composition further comprises nuts.

18. A composition according to claim 1, wherein the composition contains a maximum of about 12 grams of net carbohydrates per one ounce serving.

19. A composition according to claim 1, wherein the composition contains a minimum of about 1 gram of net carbohydrates per one ounce serving.

20. A composition according to claim 8, wherein the ratio of sugar alcohol to high intensity sweetener is from about 99:1 to about 1:99.

21. A composition according to claim 8, wherein ratio of the sugar alcohol to high intensity sweetener is about 50:50.

22. A composition according to claim 8, wherein the ratio of sugar alcohol to high intensity is about 90:10.

23. A composition according to claim 8, wherein the ratio of sugar alcohol to high intensity sweetener is about 15:85.
